(19) United States
(12) Patent Application Publication
(10) Pub. No.: US 2024/0401989 A1
(43) Pub. Date: Dec. 5, 2024

(54) FLEXIBLE ELONGATE MEMBERS IN SEWAGE PIPELINES OR CHANNELS

(71) Applicant: Leak Detector AS, Sandnes (NO)

(72) Inventor: Morten Talgø, Sandnes (NO)

(73) Assignee: Leak Detector AS, Sandnes (NO)

(21) Appl. No.: 18/695,380

(22) PCT Filed: Sep. 27, 2022
(86) PCT No.: PCT/NO2022/050222

§ 371 Date: Mar. 26, 2024

(30) Foreign Application Priority Data
Sep. 27, 2021 (NO) 20211153

(51) Int. Cl. G01D 5/353; E03F 7/12; G01K 11/3206

(52) U.S. Cl. CPC G01D 5/35374; E03F 7/12; G01K 11/3206

(57) ABSTRACT

A flexible elongate member has at least one optical sensing fiber and is configured to be at least partially submerged or float in waste fluid inside a sewage pipeline or channel for obtaining distributed measurement data along the waste fluid flow. An apparatus is for use in obtaining distributed measurement data from a sewage pipeline or channel. The apparatus has a flexible elongate member in and deployment means for deploying the flexible elongate member in the waste fluid of the sewage pipeline or channel. Furthermore, a method is for obtaining distributed sensor measurements along a sewage pipeline or channel and a method is for deploying a flexible elongate member in a sewage pipeline or channel.

### CROSS-REFERENCE TO RELATED APPLICATIONS

This application is the U.S. national stage application of International Application No. PCT/N02022/050222, filed Sep. 27, 2022, which international application was published on Mar. 30, 2023 as WO 2023/048580 A1 in the English language. The International Application claims priority to Norwegian Patent Application No. 20211153, filed Sep. 27, 2021. The international application and Norwegian application are incorporated herein by reference, in their entirety.

### FIELD

The invention relates to sewage systems, and in particular, it relates to the provision of flexible elongate members in sewage pipelines or channels of a sewage system for obtaining distributed measurement data along the flow of the waste fluid.

### BACKGROUND

Sewer systems, transporting wastewater to treatment plants, are typically monitored to ensure adequate maintenance. A problem that can occur in the sewage system is the infiltration of unwanted water into the sewage system. The infiltration of unwanted water could be caused by illicit cross-connections between the wastewater system and stormwater drains. It could also be caused by parted pipeline sections, erosion, or other damage to the system barriers. This may cause overloading of the sewage system, an increased risk of flooding, a decrease in the performance of the wastewater system, which in turn can cause an increase in maintenance costs.

Some methods to detect infiltration of unwanted water is by Distributed Temperature Sensing (DTS), Distributed Acoustic Sensing (DAS) and Fiber Bragg Grating (FBG) sensing. Generally, these methods are implemented using an optical fiber which is placed in a wastewater pipeline and is connected to a laser and a measurement system at one end. A light pulse is emitted to produce an optical signal that travels in the fiber. For DTS and DAS a part of the signal is reflected in the opposite direction due to scattering of the light in the optical fiber medium. This reflection happens continuously along the length of the optical fiber. The reflected light is detected by the measurement system which allows for fluid properties to be monitored along the length of the optical fiber. For FBG sensing the reflection instead happens at a number of discrete, prepared points with a relatively high signal-to-noise ratio. For DTS and FBG sensing the location of the infiltration of unwanted water can be detected if the infiltrated water has a different temperature than the wastewater. For DAS acoustic signals are analysed to locate the infiltration.

The DTS systems used today for detecting water infiltration in pipelines of sewer systems typically comprise cables installed at the bottom of the pipelines, where the optical fiber is positioned inside the cable, and usually fastened to the bottom by clamps. The task of installing such a structure can be quite onerous and time-consuming. Objects, such as napkins and wet wipes, which end up in the sewer system, often in large quantities, have been found to get stuck on the cable installation, which may cause significant blockages and may negatively affect the quality of the measured data. Removing objects from the cable can be difficult and takes time.

### SUMMARY

At least one aim of the present invention is to obviate or at least mitigate one or more drawbacks of the prior art.

According to a first aspect of the invention, there is provided a flexible elongate member comprising at least one optical sensing fiber and being configured to be at least partially submerged or float in waste fluid inside a sewage pipeline or channel for obtaining distributed measurement data along the pipeline or channel.

More specifically, the flexible elongate member is typically deployable and movable within the sewage pipeline or channel, in use, to utilize the waste fluid to align the flexible elongate member to extend along the sewage pipeline or channel to obtain an operational position for obtaining the distributed measurement data.

The at least one optical sensing fiber within the flexible elongate member may be used to measure one or more properties of the contents of the pipeline or channel, for example one or more properties of the waste fluid. When deployed in a sewage pipe or channel, the flexible elongate member can be aligned to extend along the pipeline or channel by a current of the waste fluid in the pipeline or channel to facilitate obtaining the measurement data. Further, the flexible elongate member may be free to be movable laterally from side to side, in particular toward a distal end, when in use in the pipeline or channel. The flexible elongate member may typically also be free to be movable upwardly in the waste fluid within the pipeline or channel or be positionable in the waste fluid spaced away from the bottom of the pipe or channel, when in use therein. Accordingly, the flexible elongate member can conveniently obtain a configuration in the pipeline or channel that may be suitable for performing measurements. Furthermore, the flexible elongate member may also be responsive to the waste fluid current and be self-supported upon the waste fluid. This may reduce or avoid having objects stuck to the member, avoid blockage and/or further facilitate measurement data quality. The installation of the flexible elongate member in the sewage pipeline or channel and its subsequent retrieval can be carried out quickly and efficiently. For example, deployment or retrieval may be possible simply by feeding the flexible elongate member into or out of the pipe or channel, and typically without personnel requiring personal protective equipment, or without personnel coming into contact with the contents of the pipe or channel such as solids, liquids and toxic gasses. The flexible elongate member can be provided and installed without imparting strain to or otherwise affecting or interfering with the structure of the pipeline or channel.

The flexible elongate member may be used to measure one or more properties of the contents of the sewage pipeline or channel.

The flexible elongate member may comprise at least one layer of or comprising load bearing fibers. The load bearing fibers may surround a core of the flexible elongate member. The load bearing fibers may comprise polyethylene fibers, polyamide fibers, aramid fibers or other fibers of other materials. The load bearing fibers may comprise Dyneema® polyethylene fibers.

In some examples, the flexible elongate member may have an outer jacket. The outer jacket may typically have a smooth outer surface which may reduce or avoid the possibility of objects, such as napkins and wet wipes, in the sewer flow getting stuck on the flexible elongate member. The outer jacket may comprise, or consist essentially of, extruded Thermoplastic Polyurethane (TPU) material or another elastic material.

Typically, the flexible elongate member may have a density equal to or less than the density of the waste fluid. The density of the flexible elongate member is typically in the range of 0.80 to 0.99 g/cm³.

In examples where the flexible elongate member may comprise at least one layer of or comprises load bearing fibers, the material of the load bearing fibers may typically have a density in the range of 0.80 to 0.99 g/cm³.

In examples where the flexible elongate member has an outer jacket, the material of the outer jacket typically has a density in the range of 0.80 to 1.1 g/cm³.

The density of waste fluid in a sewage pipe is typically in the range of 0.995 to 1.003 g/cm³.

The flexible elongate member may be configured such that the combined density of the assembly is equal to or lower than the waste fluid. The flexible elongate member may include or be provided with at least one additional low-density component and/or layer having an effective density less than 1.0 g/cm³ such that the combined density of the assembly is equal to or lower than the waste fluid. This component may be a component of a low-density material. The component may comprise gas.

The flexible elongate member is typically configured for being substantially free of torsion effects, for avoiding rotation of the flexible elongate member when under load. The flexible elongate member may have a layer of fibers which may be braided with lay angles of the braided fibers in the braid extending around a core of the flexible elongate member in opposite directions, e.g. clockwise and anticlockwise around the core. The flexible elongate member may alternatively or in addition have a first layer of fibers with lay angles in one direction, e.g. clockwise, around a core of the flexible elongate member, and a second layer of fibers with lay angles in an another direction, e.g. anticlockwise. Thus, the forces of fibers in one direction may in this way cancel those to reduce and/or substantially eliminate tendency of fibers imparting rotational forces about the long axis of the flexible elongate member under load. Thus, the torsion effects may be prevented by the flexible elongate member having a fiber lay with at least two layers in opposite direction, or in braid design. This can be advantageous when unspooling the flexible elongate member from a drum because it may prevent permanent coiling or twisting of the flexible elongate member when unspooling it from a drum. This may reduce or avoid objects, such as napkins and wet wipes, in the waste fluid getting stuck on the flexible elongate member. Furthermore, this may allow the flexible elongate member to obtain a more beneficial operational configuration in the sewer system. In this way, the quality of the measured data may be improved.

The flexible elongate member may be a length of a rope or a cable.

The flexible elongate member may have at least one streamlining formation on an outer surface. The streamlining formation may comprise a striation or rib extending longitudinally along the elongate member. When the flexible elongate member in use is located in a flow of the waste fluid, the waste fluid in the flow may exert a component of force to the streamlining formation, and may thus urge the flexible elongate member to align with a direction of the flow, and/or straighten and/or stabilise laterally the flexible elongate member in the pipeline.

The flexible elongate member may have an outer surface that may be configured for preventing materials or objects such as napkins, wet wipes, or the like in the waste fluid from getting caught on the flexible elongate member in use. The variation in outer diameter of the rope along its length when in use in the waste fluid may typically be less than 1 to 2 mm. This may avoid blockage and facilitate measurement and data quality.

According to a second aspect of the invention, there is provided an apparatus for use in obtaining distributed measurement data from a sewage pipeline or channel containing a flow of waste fluid. The apparatus comprises a flexible elongate member in accordance with the first aspect of the invention, and deployment means for deploying the flexible elongate member in the waste fluid of the pipeline or channel. More specifically, the deployment means is typically a deployment means for deploying the flexible elongate member (2) in the waste fluid (51) of the sewage pipeline or channel (5), so that a length of the flexible elongate member at least partially submerged or floating upon the waste fluid (51) and movably disposed within the sewage pipeline or channel is arranged for using the waste fluid to align the flexible elongate member to extend along the sewage pipeline or channel, so obtain an operational position in which said length extends along the sewage pipeline or channel.

Typically, the deployment means may comprise at least one retainer for retaining or positioning the flexible elongate member with respect to the sewage waste fluid flow at an upstream position along the waste fluid flow. The apparatus may include at least one drag device or drag element for configuring the flexible elongate member to extend along the sewage waste fluid flow at least partially submerged or floating in the waste fluid, between the upstream position and a downstream position along the waste fluid flow. The drag device may serve to facilitate straightening out the flexible elongate member along the waste fluid flow, and/or may act to align the length of the flexible elongate member, in response to components of force imparted upon the drag device by the flow of the waste fluid. In some examples, the drag device may be releasably or removably coupled to the flexible elongate member, so that it can be released and/or removed from the flexible elongate member when the installation of the flexible elongate member in the sewage pipeline or channel is complete. The drag device may be coupled to the flexible elongate member through a coupling comprising a release mechanism. The drag device may thus be released by operating the release mechanism. The drag device, the coupling, or the release mechanism may disintegrate, e.g. dissolve, after being in contact with the waste fluid for a period of time, so that the drag device is removed from the flexible elongate member. The removal of the drag device when the flexible elongate member is in an operational configuration in the pipe or channel may be beneficial as it may reduce or avoid objects, such as napkins and wet wipes, in the waste fluid getting stuck on the apparatus. This may in turn avoid blockage of the waste fluid flow and facilitate measurement and data quality.

The deployment means may include a drum for storing and/or spooling out the flexible elongate member. In embodiments where the deployment means includes a drum, the retainer may be a drum brake.

Typically, a length of the flexible elongate member being at least partially submerged or floating upon the waste fluid and extending freely to an end in the sewage pipeline or channel. The flexible elongate member may be retained or positioned with respect to the sewage pipeline or channel at an upstream position along the pipeline or channel. When so retained or positioned, the length downstream from the retainment location may extend freely toward the end, thus said downstream length may not be required to be further retained or suspended from the pipe, etc. The end may comprise a drag device. The end, e.g. when a drag device is not used, may comprise a section of the flexible elongate member itself.

Typically, the flexible elongate member may be arranged to extend from the retainer toward a distal end, and the drag device may be releasably coupled to the distal end of the flexible elongate member. The drag device may comprise an anchor structure or drogue structure. Furthermore, the drag device may be configured to be at least partially submerged or float in the waste fluid together with the flexible elongate member. The drag element or drag device may comprise a friction surface for obtaining enhanced frictional contact or drag of the apparatus in the waste fluid for facilitating with alignment of the flexible elongate member along the waste fluid flow.

The apparatus may be deployed in the sewage system containing the flow of waste fluid.

According to a third aspect of the invention, there is provided a method of obtaining distributed sensor measurement data along a sewage pipeline or channel containing waste fluid. The method comprises the step of using a flexible elongate member in accordance with the first aspect of the invention to obtain distributed measurements data, wherein the flexible elongate member is deployed in the sewage pipeline or channel, and a length of the flexible elongate member is at least partially submerged or floating upon the waste fluid. More specifically, said length of the flexible elongate member that is at least partially submerged or floating upon the waste fluid is typically movably disposed within the sewage pipeline or channel, the waste fluid acting to align the flexible elongate member to extend along the sewage pipeline or channel, the flexible elongate member so obtaining an operational position in which said length extends along the sewage pipeline or channel.

The method may further comprise the step of providing an optical unit for transmitting light into the optical sensing fiber and receiving light from the optical sensing fiber to obtain measurements along the sewage pipeline.

Typically, the method may further comprise providing or using an apparatus in accordance with the second aspect of the invention.

The method may have one or more further features or steps corresponding to one or more of the features set out in relation to any of the first and/or second aspects of the invention, wherever described herein.

According to a fourth aspect of the invention, there is provided method of obtaining distributed sensor measurement data along a sewage pipeline or channel containing waste fluid, the method comprising the step of using a flexible elongate member in accordance with the first aspect of the invention to obtain the distributed measurements data, the flexible elongate member being deployed in the sewage pipeline or channel, a length of the flexible elongate member being at least partially submerged or floating upon the waste fluid and extending freely toward or to an end in the sewage pipeline or channel.

The method may include retaining or positioning the flexible elongate member with respect to the sewage pipeline or channel at an upstream position along the pipeline or channel.

When retaining the length at a location upstream, the length downstream from the retainment location may extend freely to the end and thus not be required to be further retained or suspended from the pipe, etc. The end may comprise a drag device. The end, e.g. when a drag device is not used, may comprise a section of the flexible elongate member itself.

The method of the fourth aspect may have one or more further features or steps as set out in relation to the first, second and/or third aspect.

According to a fifth aspect of the invention, there is provided a method of deploying a flexible elongate member in accordance with the first aspect of the invention in a sewage pipeline or channel containing waste fluid. The method comprises inserting the flexible elongate member into the sewage pipeline or channel, a length of the flexible elongate member being submerged in or floating upon the waste fluid. More specifically, said length of the flexible elongate member being submerged in or floating upon the waste fluid is typically movably disposed within the sewage pipeline or channel, the waste fluid acting to align the flexible elongate member to extend along the sewage pipeline or channel, the flexible elongate member so obtaining an operational position in which said length extends along the sewage pipeline or channel.

Typically, the method may further comprise spooling out the flexible elongate member from a drum and letting the flexible elongate member obtain an operational configuration in the waste fluid. In the obtained operational configuration typically, the flexible elongate member extends along the sewage pipeline and is spaced apart from the bottom of the sewage pipeline.

The method may further comprise the step of retaining the flexible elongate member at an upstream position along the pipeline, leaving the flexible elongate member to obtain an operational configuration.

The flow of waste fluid typically imparts a component of force upon the flexible elongate member to straighten, tension and/or stabilise laterally the flexible elongate member in the waste fluid. This can enhance the quality and repeatability of the measurements and can increase the quality of the data obtainable.

The method may have one or more further features or steps corresponding to one or more of the features or steps set out in relation to any of the first, second, third and/or fourth aspects of the invention, wherever described herein.

According to a sixth aspect of the invention there is provided a method of deploying a flexible elongate member in accordance with the first aspect of the invention in a sewage pipeline or channel containing waste fluid, the method comprising the step of inserting the flexible elongate member into the sewage pipeline or channel, a length of the flexible elongate member being submerged in or floating upon the waste fluid and extending freely to or toward an end in the sewage pipeline or channel. The waste fluid may exert a positioning or aligning force on the end or the length extending toward the end to position or align the flexible elongate member to extend along the sewage pipeline or channel.

The method of the sixth aspect may have one or more further features or steps as set out in relation to any of the first, second, third, fourth and/or fifth aspects of the invention.

### BRIEF DESCRIPTION OF THE DRAWINGS

There will now be described, by way of example only, embodiments of the invention with reference to the accompanying drawings, in which:

FIG. 1 is a schematic representation of apparatus for use in a sewage pipeline;

FIG. 2 is a schematic representation of another apparatus for use in a sewage pipeline;

FIG. 3 is a cross-section of yet another apparatus for use in a sewage pipeline;

FIG. 4 is a schematic representation of a flexible elongate member of the apparatus of FIG. 3 in smaller scale; and

FIGS. 5A and 5B are schematic representations of the apparatus of FIG. 1, in smaller scale, in use, during deployment and in use after deployment into sewage pipeline.

### DETAILED DESCRIPTION

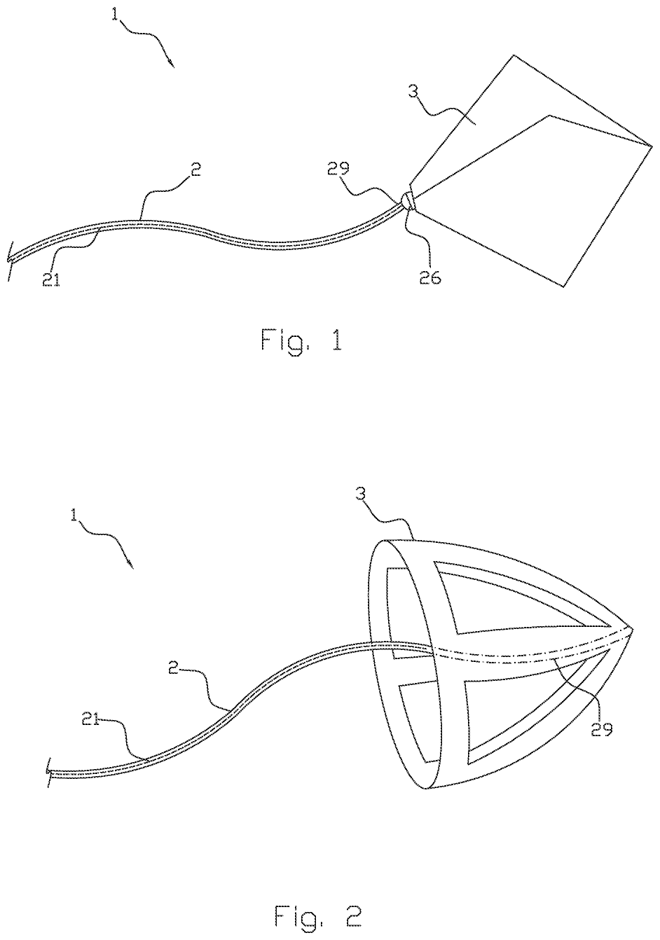

FIG. 1 shows an apparatus 1 that includes a flexible elongate member in the form of a rope 2. An optical sensing fiber 21 is incorporated into the rope 2. The flexible elongate member in other examples is a cable of polyethylene fibers or a cable or rope of other lightweight material or fibers. The density of the materials of the rope 2 is configured such that the rope can float or is at least partially submerged in the waste fluid in use.

The apparatus 1 shown in FIG. 1 also includes a drag device 3, coupled to the distal end 29 of the rope 2.

An alternative apparatus 1 is shown in FIG. 2 where the drag device 3 has the form of a drogue structure. In another variant, the drag device 3 is releasably attached to the flexible elongate member by a release mechanism 26.

When at least partially submerged or floating upon the waste fluid in the pipeline, a flow of the waste fluid acts upon the surfaces of the rope and/or the drag device 3 so that the rope 2 can straighten out along and align with the direction of flow of the waste fluid. The flow exerts a frictional drag upon the apparatus 1. The drag of the apparatus in the flow is effectively increased by the presence of the drag device 3. In the example of FIG. 2, the fluid may act against an inner end member of the drag member to urge it downstream in the flow. In general, the drag device 3 can be any type of member suitable for facilitating to increase the drag characteristics of the apparatus and urging the rope 2 to straighten and align along the flow of waste fluid.

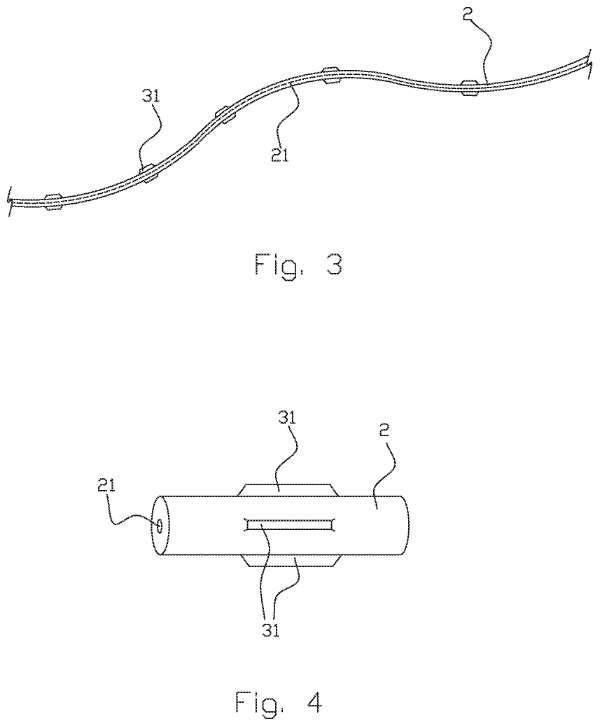

In FIGS. 3 and 4, a flexible elongate member in the form of a rope 2 has several streamline formations 31 which are arranged along the rope 2. The streamline formations 31 can help with aligning the rope 2 in the flow of waste fluid in a sewage pipeline. The streamline formations 31 are in this example arranged by fours along the perimeter of the rope 2, but can in other examples be provided in any other arrangement as seen fit. They may increase the drag of the rope 2, and in this sense may to some extent protrude from an outer surface of the rope, but preferably are configured so that materials such as napkins or wet wipes or the like in the waste fluid do not get caught on the streamline formations.

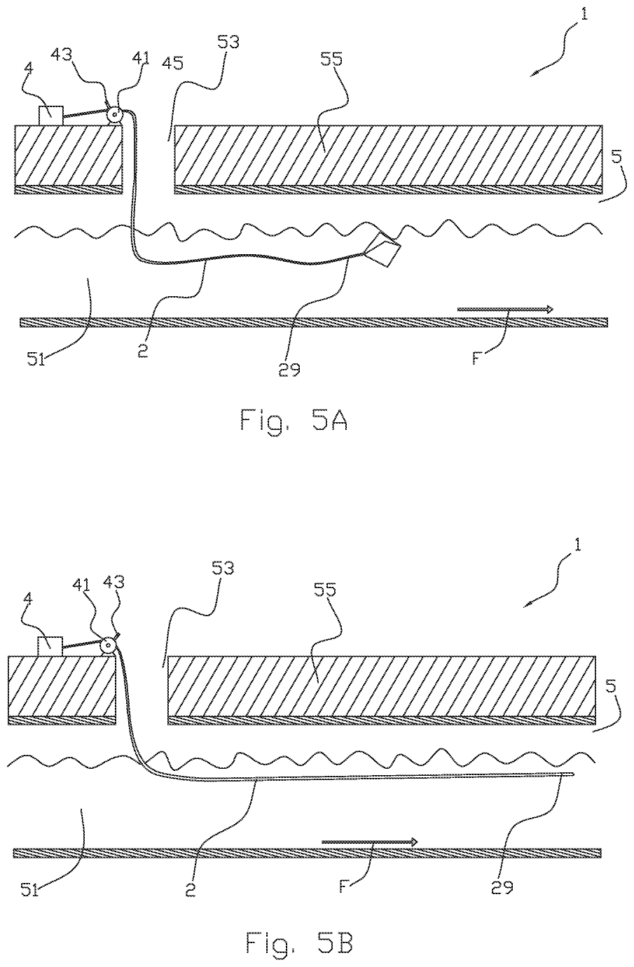

Referring to FIG. 5A, the apparatus 1 is shown during deployment into a section of a sewage pipeline 5. The pipeline is buried under the ground 55, containing waste fluid 51. A part of the rope 2 comprising the drag device 3 is located inside the sewage pipeline 5 at least partially submerged or floating upon the waste fluid. A deployment means including a drum 41 spools out the rope 2 through a manhole 53 into the sewage pipeline 5. The drum 41 comprises a retainer in the form of a drum brake 43, which is in an open position in FIG. 5A. The waste fluid 51 is flowing in a direction F. The flow imparts a force on the rope 2 and on the drag device 3. The rope 2 is left to obtain naturally an operational configuration in the pipeline, in which the rope 2 is supported floatingly and/or is at least partially supported upon the waste fluid and extends along the pipeline and is spaced away from the bottom for obtaining measurement data. The flow carries the apparatus 1 along the current and further into the sewage pipeline 5, as the drum 41 spools out the rope 2.

In FIG. 5B the apparatus is ready for performing distributed measurements in the sewage pipeline 5 with the rope 2 having obtained the operational configuration. The drum brake 43 is in a locked position, so that the rope 2 is fixedly held to the drum 41. The drag device 3 has been removed or has disintegrated to avoid objects in the waste fluid flow getting stuck on the drag device. The flow of waste fluid is still imparting force upon the rope 2, against the retainment from the brake to tension and/or align the rope 2 along the pipe. The rope 2 in FIG. 5B is therefore straightened out and extends along the pipeline. In FIGS. 5A and 5B only a short length of the rope 2 is shown immersed in the waste fluid 51, but it will be appreciated that in operational use, the rope 2 inside the sewage pipeline 5 can be of any suitable length and typically longer.

The rope 2 has an optical sensing fiber 21 extending along the rope 2 (see FIGS. 1 to 4). The optical sensing fiber 21 may have gratings to allow discrete detection of parameters of the contents of the pipeline using the sensing fiber. The optical sensing fiber 21 may also be a longitudinally homogenous fiber for obtaining a continuous reflection of the signal. The optical sensing fiber 21 may detect parameters or properties of the waste fluid, such as temperature and pressure or other parameters along the optical sensing fiber 21. When the rope is straightened out, the length of the fiber corresponds to the same length in the sewage pipeline 5. The optical sensing fiber 21 is connected to an optical unit 4. The optical unit 4 is configured for transmitting light into the optical sensing fiber 21 and receiving light from the optical sensing fiber 21. A light source within the optical unit 4 is arranged to transmit light signals through the optical sensing fiber 21. The signals may be reflected from the gratings and received by the optical unit 4. The signals may also be continuously reflected in an optical sensing fiber 21 that is longitudinally homogenous. The detected, reflected signals can be processed to obtain information about the surrounding waste fluid 51 at the detection locations. A change in for example temperature along a section of the rope 2 may indicate an infiltration of unwanted water into the sewage pipeline 5. The optical sensing fiber 21 may also be used for other measurements, e.g. distributed pressure measurements, Distributed Acoustic Sensing, or Fibre Bragg Grating sensing.

The drag device in any of the above examples may alternatively be a drift anchor for drifting downstream in the flow. In other examples, no drag device at all is required or used.

Typically, the length of the flexible elongate member ends at a free end in the pipeline. Further typically, the free end is movable within the sewage pipeline or channel, e.g. laterally. Such free end arrangement may facilitate movement and alignment of the elongate member along the sewage pipeline or channel. The flexible elongate member may thus have an end which may comprise the drag device. In other variants, the flexible elongate is deployed and used without any such drag device. In such variants the end of the flexible elongate member may be a section of flexible elongate member.

1. A flexible elongate member comprising at least one optical sensing fiber and being configured to be at least partially submerged or float in waste fluid inside a sewage pipeline or channel for obtaining distributed measurement data along a flow of the waste fluid, the flexible elongate member being deployable and movable within the sewage pipeline or channel, in use, to utilize the waste fluid to align the flexible elongate member to extend along the sewage pipeline or channel to obtain an operational position for obtaining the distributed measurement data.

2. The flexible elongate member as claimed in claim 1, further comprising at least one layer of load bearing fibers around the optical sensing fiber, wherein the fiber comprise polyethylene fiber or polyamide fiber.

3. (canceled)

4. The flexible elongate member as claimed in claim 1, further comprising an outer jacket.

5. (canceled)

6. The flexible elongate member as claimed in claim 1, having a density that is equal to or less than that of the waste fluid.

7. (canceled)

8. The flexible elongate member as claimed in claim 1 being a length of rope and configured for being substantially free of torsion effects.

9. The flexible elongate member as claimed in claim 1 having an outer surface which is smooth.

10. An apparatus for use in obtaining distributed measurement data from a sewage pipeline or channel containing a flow of waste fluid, the apparatus comprising:
a flexible elongate member comprising at least one optical sensing fiber and being configured to be at least partially submerged or float in waste fluid inside a sewage pipeline or channel for obtaining distributed measurement data along a flow of the waste fluid; and
deployment means for deploying the flexible elongate member in the waste fluid of the sewage pipeline or channel, so that a length of the flexible elongate member at least partially submerged or floating upon the waste fluid and movably disposed within the sewage pipeline or channel is arranged for using the waste fluid to align the flexible elongate member to extend along the sewage pipeline or channel, so obtain an operational position in which said length extends along the sewage pipeline or channel.

11. The apparatus as claimed in claim 10, wherein said deployment means comprises:
at least one retainer for retaining or positioning the flexible elongate member with respect to the sewage pipeline or channel at an upstream position along the sewage pipeline or channel; and
at least one drag device, which is releasably coupled to the flexible elongate member or dissolvably removable from the flexible elongate member, for configuring the flexible elongate member to extend along the waste fluid flow at least partially submerged in the waste fluid, between the upstream position and a downstream position along the sewage pipeline or channel.

12. The apparatus as claimed in claim 11, wherein the deployment means includes a drum for spooling out the flexible elongate member, and the at least one retainer is a drum brake.

13. The apparatus as claimed in claim 11, wherein the flexible elongate member is arranged to extend from the at least one retainer toward a distal end, and the drag device is releasably coupled to the distal end of the flexible elongate member.

14. The apparatus as claimed in claim 11, wherein the drag device comprises an anchor structure or drogue structure and is configured to be at least partially submerged or float in the waste fluid together with the flexible elongate member.

15. (canceled)

16. The apparatus as claimed in claim 10, deployed in the sewage pipeline or channel containing the flow of waste fluid.

17. A method of obtaining distributed sensor measurement data along a sewage pipeline or channel containing waste fluid, the method comprising the step of using a flexible elongate member comprising at least one optical sensing fiber and being configured to be at least partially submerged or float in waste fluid inside a sewage pipeline or channel for obtaining distributed measurement data along a flow of the waste fluid, to obtain the distributed measurements data, the flexible elongate member being deployed in the sewage pipeline or channel, a length of the flexible elongate member being at least partially submerged or floating upon the waste fluid and movably disposed within the sewage pipeline or channel, the waste fluid acting to align the flexible elongate member to extend along the sewage pipeline or channel, the flexible elongate member so obtaining an operational position in which said length extends along the sewage pipeline or channel.

18. A method of obtaining distributed sensor measurement data along a sewage pipeline or channel containing waste fluid, the method comprising the step of using a flexible elongate member comprising at least one optical sensing fiber and being configured to be at least partially submerged or float in waste fluid inside a sewage pipeline or channel for obtaining distributed measurement data along a flow of the waste fluid, to obtain the distributed measurements data, the flexible elongate member being deployed in the sewage pipeline or channel, a length of the flexible elongate member being at least partially submerged or floating upon the waste fluid and extending freely to an end in the sewage pipeline or channel.

19. The method as claimed in claim 17, which further comprises: providing an optical unit for transmitting light into the at least one optical sensing fiber and receiving light from the at least one optical sensing fiber to obtain measurements along the sewage pipeline or channel.

20. The method as claimed in claim 17, which further comprises providing an apparatus in accordance with claim 10.

21. A method of deploying a flexible elongate member comprising at least one optical sensing fiber and being configured to be at least partially submerged or float in waste fluid inside a sewage pipeline or channel for obtaining distributed measurement data along a flow of the waste fluid, or an apparatus in accordance with claim 10, in a sewage pipeline or channel containing waste fluid, the method comprising the step of inserting the flexible elongate member into the sewage pipeline or channel, a length of the flexible elongate member being submerged in or floating upon the waste fluid and movably disposed within the sewage pipeline or channel, the waste fluid acting to align the flexible elongate member to extend along the sewage pipeline or channel, the flexible elongate member so obtaining an operational position in which said length extends along the sewage pipeline or channel.

22. A method of deploying a flexible elongate member comprising at least one optical sensing fiber and being configured to be at least partially submerged or float in waste fluid inside a sewage pipeline or channel for obtaining distributed measurement data along a flow of the waste fluid, or an apparatus in accordance with claim 10, in a sewage pipeline or channel containing waste fluid, the method comprising the step of inserting the flexible elongate member into the sewage pipeline or channel, a length of the flexible elongate member being submerged in or floating upon the waste fluid and extending freely to an end in the sewage pipeline or channel.

23. The method as claimed in claim 21, which further comprises:
spooling out the flexible elongate member from a drum; and
letting the flexible elongate member obtain an operational configuration in the waste fluid in which the flexible elongate member extends along the sewage pipeline or channel and is spaced apart from a bottom of the sewage pipeline or channel.

24. The method as claimed in claim 23, which further comprises retaining the flexible elongate member at an upstream position along the sewage pipeline or channel, leaving the flexible elongate member to obtain an operational configuration.

25. The method as claimed in claim 21, which further comprises removing a drag device from the flexible elongate member by letting the drag device dissolve or by releasing the drag device therefrom.
